(19) United States
(12) Patent Application Publication
(10) Pub. No.: US 2021/0334390 A1
(43) Pub. Date: Oct. 28, 2021

(54) System for on-demand capture and exchange of media items that are not recorded at the point of capture

(71) Applicant: EYE Media, LLC, Dallas, TX (US)

(72) Inventors: Chijioke Ekenedilichukwu Offor, Dallas, TX (US); Mimi Haiqian Yu, Dallas, TX (US); Samuel Eugene Joyner, Dallas, TX (US); Joseph William Micheli, Dallas, TX (US)

(21) Appl. No.: 17/238,019

(22) Filed: Apr. 22, 2021

Related U.S. Application Data
(60) Provisional application No. 63/013,716, filed on Apr. 22, 2020.

(51) Int. Cl. G06F 21/60; H04L 29/08; G06F 3/0484; H04L 29/06

(52) U.S. Cl. CPC G06F 21/606; H04L 63/0884; G06F 3/04842; H04L 67/36

(57) ABSTRACT

According to one embodiment, a system for secured unidirectional media exchange comprising a first user interface device, a second user interface device, a server, and an application having a user interface. Wherein said application comprises code capable of receiving a first unique user identifier associated with a first instance of the user interface through a second instance of the user interface. Wherein said second instance of the user interface is associated with a second unique user identifier and executes on said second user interface device. Capturing a media item set through the second instance of the user interface using media sensor hardware of said second user interface device, and storing said media item set in a database such that said media item set is securely deleted from the second user interface device after being stored. Associating said first unique user identifier with each media item in the media item set; storing, in the database, said associated first unique identifiers. Receiving, from the first instance of the user interface, a unique user identifier associated with said first instance of the user interface, wherein said first instance of the user interface executes on said first user interface device, and sending the media item set to said first instance of the user interface.

### RELATED APPLICATION

This application is based on and claims priority to and the benefit of Provisional U.S. Patent Application 63/013,716, filed on Apr. 22, 2020, the entirety of which is incorporated herein by reference.

### FIELD OF THE INVENTION

This invention relates generally to the secure storage and exchange of media items between two clients through a server system. More particularly, the present invention relates to a media sharing platform for secure unidirectional media exchange in which a receiving client receives a media item from a sending client through a server, without the sending client or the server retaining a copy of the media item.

### BACKGROUND

Securely exchanging media with another user is a problem which has become increasingly prevalent as mobile phones and digital cameras have become ubiquitous in the lives of much of the population. For example, a user often wishes to transfer media, such as a photo or video he/she has taken, to another user. Transfer of this media may be achieved in a number of ways, for example by sending the media via a messaging system, such as text or email, or by uploading the media to a social media site where it is made available to users to whom the uploader has granted viewing permissions.

These solutions, however, are not satisfactory for many users. A user may not wish to provide social media services with a copy of his/her media, knowing that such services often store uploaded media for analytic and advertisement purposes. Further, in some instances a user may not wish to share his/her contact information, such as a phone number or email, for example, when requesting that an unfamiliar person at a concert or other event to take a photo. The alternative in such a situation is not much better, a user may choose to hand their own phone to the unknown person so that it can be used to take the photo, but this risks the device being stolen or damaged by carelessness.

Such problems are only magnified for professional photographers, who may wish to sell their services at, for example, events where there are many people who would be interested in purchasing photo or video memorabilia. The difficulty of arranging future transfer of the media or otherwise collecting information which a customer might not wish to share in order to later transfer the media, along with concerns by the customer that the photographer might make unwanted use of the photos once captured, may all discourage a potential customer from recruiting the services of a photographer.

In recognition of these problems, the present invention offers new and useful solutions which enable a user who captures media to input a unique identifier for a user who wishes to receive the media. Using a technique for secure unidirectional media exchange, the user can then upload media to a server without actually storing it permanently on their device. The server may then provide that media to the receiving user for a period of time, making it available for download, before also deleting the media. The result is that the receiving user can obtain the desired media both quickly and without the uncertainty described above. Further, the photographer may benefit by the addition of payment mechanisms to some embodiments consistent with present invention which enable him/her to obtain payment from the receiving user before the media is provided to them.

### SUMMARY

The present invention relates to systems, methods, and devices for on-demand capture and exchange of media items without recording them at the point of capture. In particular, the present invention relates to server systems, client devices, and methods operable thereon in order to implement secure unidirectional media exchange, in which a sender transmits a media item to a server which in turn transmits said media item to a receiver, without permanently storing the media item on the sender or server.

According to one embodiment, a system for secured unidirectional media exchange comprising a first user interface device, a second user interface device, a server, and an application having a user interface. Wherein said application comprises code capable of receiving a first unique user identifier associated with a first instance of the user interface through a second instance of the user interface. Wherein said second instance of the user interface is associated with a second unique user identifier and executes on said second user interface device. Capturing a media item set through the second instance of the user interface using media sensor hardware of said second user interface device, and storing said media item set in a database such that said media item set is securely deleted from the second user interface device after being stored. Associating said first unique user identifier with each media item in the media item set; storing, in the database, said associated first unique identifiers. Receiving, from the first instance of the user interface, a unique user identifier associated with said first instance of the user interface, wherein said first instance of the user interface executes on said first user interface device. And sending the media item set to said first instance of the user interface.

According to another embodiment, a method for secured unidirectional media exchange, the method comprising receiving, from a first client application, a media upload request including one or more media items, wherein each media item is associated with a first unique identifier. Storing each of the one or more media items in a time-managed data container corresponding to the first unique identifier associated with said media item, wherein said storing further includes generating the time-managed data container corresponding to said first unique identifier if one does not exist. Receiving, from a second client application, a media inventory request including a second unique identifier. Responding to said media inventory request with a list of available media items based on a determination of whether or not the second client application is authorized to make the request, and a comparison between the first unique identifier and the second unique identifier; monitoring the time-managed data container to determine if a termination condition has occurred, and securely deleting the time-managed data container and its contents upon determining that a termination condition has occurred.

According to yet another embodiment, a secured unidirectional media exchange device comprising at least one non-transitory memory storing instructions; a display, media sensor hardware, a network interface, an input interface, and one or more processors in communication with at the at least one non-transitory memory, the display, the media sensor hardware, the network interface, and the user input interface. Wherein the one or more processors execute the instructions to cause the device to present a user interface on the display, the user interface configured to receive input from the input interface; receive, through the user interface, a first unique identifier associated with a first user; transiently capture, using the media sensor hardware, one or more media items, initiate a secured unidirectional media exchange with a server, wherein initiating said secured unidirectional media exchange comprises sending the first unique identifier to the server via an application programming interface, uploading the one or more media items to the server, and securely deleting the one or more media items upon completion of said uploading; wherein the user interface is further configured to present a second unique identifier associated with a second user.

### BRIEF DESCRIPTION OF THE DRAWINGS

A more complete appreciation of the present invention and the many resulting advantages thereof, will be readily understood with reference to the following detailed description considered in connection with the accompanying drawings, wherein:

FIG. 1 illustrates an embodiment of the secured unidirectional media exchange (“SUME”) technique implemented in accordance with the present invention.

FIG. 2 illustrates a system in accordance with some embodiments of the present invention.

FIG. 3 illustrates a client device in accordance with some embodiments of the present invention.

FIG. 4 illustrates another client device in accordance with some embodiments of the present invention.

FIG. 5A, FIG. 5B, and FIG. 5C illustrate server systems in accordance with some embodiments of the present invention.

FIG. 6 illustrates a diagram of a media exchange platform in accordance with some embodiments of the present invention.

FIG. 7 illustrates a class diagram for one implementation of the time-managed data container design pattern in accordance with some embodiments of the present invention.

FIG. 8A and FIG. 8B illustrate messages which may be exchanged between a client and server in accordance with some embodiments of the present invention.

FIG. 9 is a flow chart illustrating a media management process in accordance with some embodiments of the present invention.

FIG. 10 is a flow chart illustrating the control logic of an application in accordance with some embodiments of the present invention.

FIG. 11 is a user interface storyboard illustrating a user interface in accordance with some embodiments of the present invention.

FIG. 12 illustrates unique identifiers in accordance with some embodiments of the present invention.

FIG. 13 illustrates an encryption implementation in accordance with some embodiments of the present invention.

### DETAILED DESCRIPTION

The following section includes a more detailed description of exemplary embodiments, with reference to the accompanying drawings which depict exemplary embodiments or aspects of exemplary embodiments. Inventors note, however, that the invention disclosed herein may take many forms, and should not be construed as limited to the exemplary embodiments depicted in the accompanying drawings or otherwise set forth herein. Rather, these exemplary embodiments are provided for the benefit of anyone reading this disclosure, so that they will more readily understand the scope of this disclosure and of the claimed invention. While this disclosure presents both the claimed invention and key technological aspects thereof in great detail, the inventors note that some aspects may nonetheless be omitted, for example, where techniques, structures, terminology, or other features are well-established to persons skilled in the art. In such cases, inclusion of such elementary concepts from the field of the invention would tend more to obfuscate the presented exemplary embodiments rather than clarify them, and for this reason they are not included.

The terminology used in this disclosure is presented for the purpose of describing particular embodiments only and is not intended to be limiting on this disclosure. Where they are used herein, singular forms such as “a,” “an,” and “the” are intended to incorporate their plural forms also, unless the context clearly indicates otherwise. Further, the use of terms such as “a” or “an” does not denote a limitation of quantity, but rather indicates the presence of at least one of the referenced items. It should be further understood that the terms “comprise,” “include,” “incorporate,” or any variation thereof, when used in this disclosure, specify the non-exclusive presence of stated features, regions, steps, operations, code, variables, data, elements, components, and/or groups thereof; such terms should not be read to preclude the presence of other features, regions, steps, operations, code, variables, data, elements, components, and/or groups in addition to those described.

Embodiments of the present invention include, among others, methods, apparatuses, and systems which incorporate the performance of a specialized mode of data transfer, referred to herein as secured unidirectional media exchange (“SUME”). The present disclosure additionally provides a number of programmatic structures, such as the time-managed data container, on which some exemplary embodiments depend. The present invention is directed toward particular embodiments which incorporate these ideas as key components. Such embodiments may describe, for example, particular methods by which a computer system might be constructed to perform SUME. These embodiments may additionally describe, for example, particular devices which serve as components (for example, clients) of systems performing SUME. As yet another example, these embodiments may describe systems in which one or more devices participate in the secured unidirectional exchange of media through one or more servers configured to accomplish one embodiment of this included concept. As the name of the term implies, the SUME technique aims to affect secure transfer of media, for example, a media file like a video, audio, text, photo, or other form of media item. With this in mind, the first disclosure of this detailed description aims to explain SUME broadly.

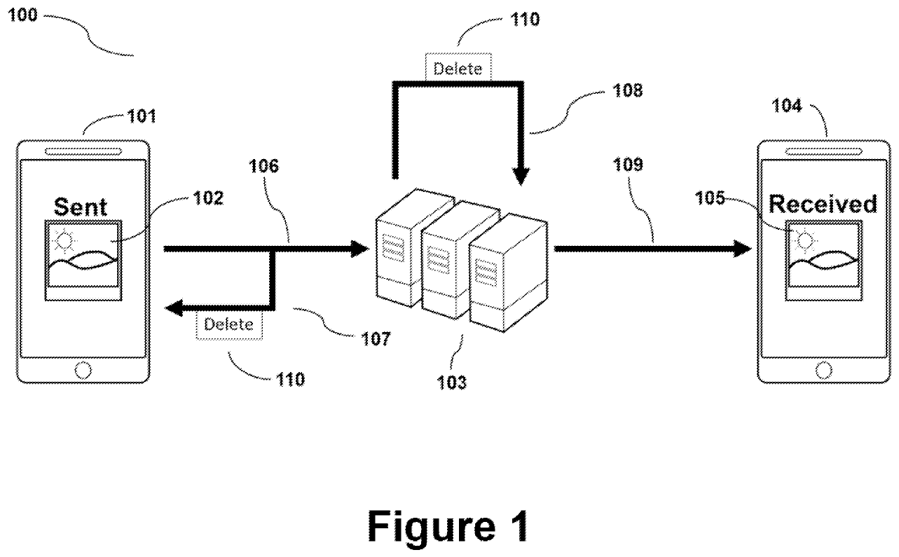

FIG. 1 shows the secured unidirectional media exchange (“SUME”) technique, generally, in the form of a flow-chart 100 depicting one way in which the technique may be used according to some embodiments of the present invention. For example, a client device 101 may hold within its memory some media 102 which is intended to be exchanged through the execution of SUME. This media is then transferred 106 to a server or other repository 103 for storage. Upon successful completion of this transfer, the client device 101 causes itself 107 to securely delete 110 the media 102. The server or repository 103, in turn, holds the media 102 for a time, during which it awaits some condition, for example, the passage of a particular amount of time, the receipt of a signal, the alteration of an internal variable, etc. Upon this condition's occurrence, the server or repository 103 causes itself 108 to securely delete 110 the media 102 which it stores. Prior to the server or repository's 103 secure deletion 110 of the media 102, the server or repository 103 may transfer a copy of the media 109 to another client device 104, which receives it as received media 105.

The transfer 109 may occur in response to a request by the other client 104, or it may occur autonomously based on some setting or information stored by the server or repository 103, due to a message by the client 101 or another client or connected device (not depicted). The occurrence of this transfer 109 may also be the condition based upon which the server or repository 103 causes itself 108 to securely delete 110 the stored media 102. Such details of the implementation used in executing SUME 100 are not crucial to the particular embodiments herein which make use of the technique; rather, the technique may be accomplished where media is moved from one device (such as 101) to a temporary storage location (such as 103) and eventually to another device (such as 104) such that progressive secure deletions 110 which occur at stages during the technique 100 serve to safeguard the eponymous “unidirectional” exchange of media namesake of SUME.

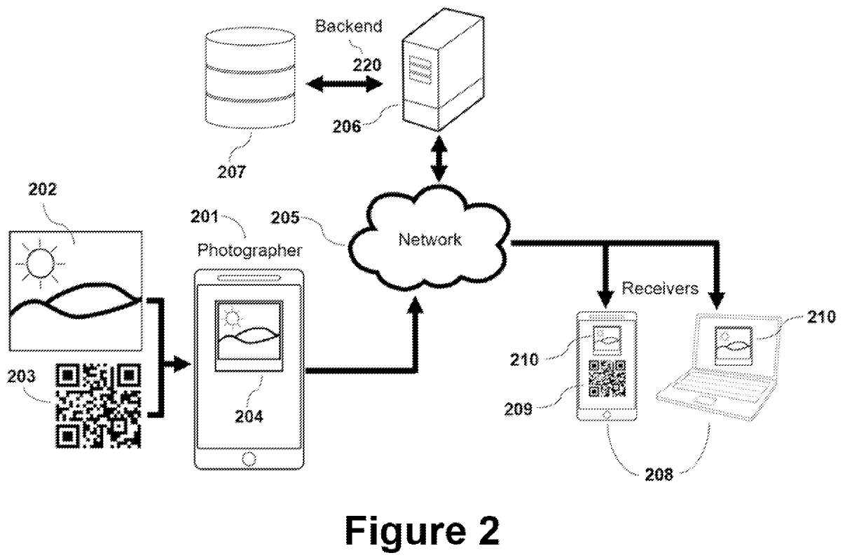

FIG. 2 depicts one exemplary embodiment of a system described by the present disclosure. For example, the embodiment may include a “photographer” client device 201 which may include media sensor hardware such as a camera for capturing visual media, for example depicting a photography subject 202 such as a landscape, or depicting a unique identifier 203 such as the QR code depicted here, though such an identifier may be acquired by other means, for example a user manually entering it or loading it from an online resource. After a photography subject 202 is captured by the client device's media sensor hardware, a media item 204 may be created in the memory of the client device 201. The client device 201 may further associate a media item 204 with a unique identifier 203, such as that encoded by a QR code. Using a network interface included within the photographer device 201, the device may then communicate both the media item 204 and associated unique identifier 203 through a network 205 to the system's backend 220, which may consist, for example, of a server 206 connected to a database or datastore 207. After communicating the media item 204 and unique identifier 203, the photographer client device 201 may then securely delete the media item 204 in accordance with the SUME technique. While the photographer client device 201 is depicted as a mobile phone running a mobile application, it should be noted that the client device 201 can take a number of forms, for example, a laptop computer, a tablet computer, or any number of other computer systems consistent with the present invention. The network 205 may include any number of telecommunications elements which serve to connect the photography client device 201, the backend 220, and any receiver client devices 208 together, for example the internet, cellular networks, local area networks, wireless networks, wired networks, Bluetooth, Wi-Fi, Wi-Fi Direct, or any combination of such technologies.

Upon receiving a media item 204 from a client device 201, the server 206 may process the received item in order to store it in the database or datastore 207 to which it is connected. Server 206 may further include services for managing the database 207, for example, an application programming interface (API) may be provided by which the contents of the database 207 may be queried or updated by both photographer and receiver client devices 201 and 208 respectively; or a database monitoring service which tracks media items stored in the database 207 in order to delete them when a deletion condition occurs, as described by the SLIME technique may be provided. The server 206 may additionally process incoming requests from receiver clients 208 in order to provide them with a list of available media items from the database 207 over the network 205.

The receiver client devices 208 may be designed to request listings of available media items 210 from the backend 220; upon receiving a list, the client devices 208 may download the media item 210 so that it can be saved on their device—the final stage of the SUME technique. As depicted, the receivers 208 may take the form of a mobile phone or laptop, however the present disclosure contemplates other possible manifestations, for example a stand-alone electronic device, a web application available via a browser, or any other combination of software and hardware capable of requesting and downloading media items 210 over the network 205. In addition to receiving and displaying media items 210, a receiver client device 208 may also be designed to display a unique identifier 209 associated with that client device so that it can be captured or otherwise entered as the unique identifier 203 used by the photographer client device 201.

It should be additionally noted that though the photographer client device 201 and receiver client devices 208 are depicted separately in the figure, they may also take the form of different portions of the same application running on a single client device. For example, a user may capture or input another user's unique identifier 203, acting as a photographer 201 in order to capture a media item 204 to be delivered to the user associated with that unique identifier 209. That same user may then act as a receiver 208, displaying his/her unique identifier 209 so that a photographer 201 can capture or enter it and deliver a captured media item to his/her device 208.

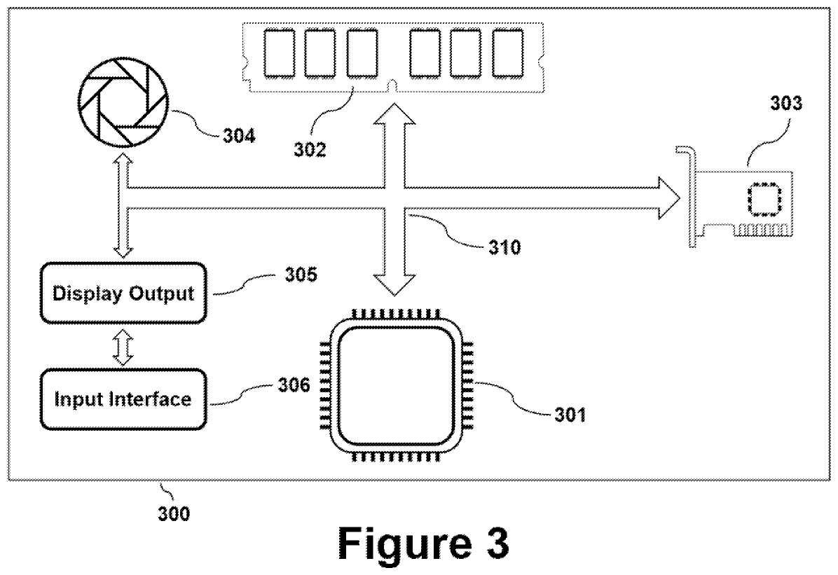

FIG. 3 depicts an exemplary embodiment of a client device 300, such as the photographer or receiver client devices 201 and 208 depicted above, consistent with the present invention. The client device 300 may take many forms, such as a mobile phone, tablet, laptop, personal computer, or other electronic device designed and built to include the features described herein. For example, the exemplary device may include a processor 301 connected to memory 302 by through a data bus 310, which may additionally connect said processor 301 and memory 302 to a network interface 303, media sensor hardware 304, and a display output 305 which may be additionally connected to an input interface 306. The processor 301 may take the form of a single chip package as depicted, for example, a modern single or multi-core central processing unit (“CPU”) such as the Qualcomm Snapdragon or Apple A Series of chip which are specifically adapted for use in mobile devices, or alternatively an Intel Core series or AMD Ryzen or ThreadRipper series more commonly included in desktop and laptop computers. The present disclosure additionally contemplates that the processor 301 may include one or more additional processors, for example in a system which takes advantage of multiple CPUs operating in parallel, or in a system which incorporates a graphics processing unit (“GPU”) which operates in conjunction with the CPU in order to display graphical output and/or perform additional operations on data at the direction of the CPU. In some embodiments, the processor 301 may additionally be a hybrid processor, incorporating both standard CPU as well as GPU architectures in a single chip. In still other embodiments, the processor 301 may take the form of an application-specific integrated circuit designed and built to perform specifically the operations necessary to the client device 300 without the general programmability of a CPU or GPU, or may comprise entirely or in part, reconfigurable processor hardware such as a field-programmable gate array. The processor 301 may serve to execute instructions, code, or other software stored on the memory 302 in order to control the network interface 303, media sensor hardware 304, display output 305, or input interface 306 or to manage data between them.

The memory 302 may take the form of random-access memory (“RAM”) connected to the processor 301 via the data bus 310. For example, some embodiments may include dynamic random-access memory (“DRAM”), a volatile form of memory which retains its contents only so long as power is supplied. Alternatively, the memory 302 may take a non-volatile form of randomly accessible storage, such as that used in modern solid-state disks (“SSD”), or non-volatile non-randomly accessible storage such as a hard disk, optical disk, or other medium capable of storing data. In some embodiments, the memory 302 may take the form of multiple memory or storage locations operating together to supply data to the processor 301 and other components of the client device 300, for example, in a system incorporating both DRAM and an SSD or other non-volatile storage. In such embodiments, the processor 301 may cause the memory 302 to move executable code from the SSD to the DRAM so that it is available to execute by the processor when it is needed. In some embodiments, the memory 302 may also include read-only memory (“ROM”) which may be used to store executable code for the processor 301, particularly in lightweight or embedded versions of the client device 300.

The network interface 303 may take the form of one or more chips or peripheral devices incorporated into the client device 300. For example, the network interface 303 may be a network card or integrated network chip which allows the client device 300 to connect to a local area network or the internet via ethernet or Wi-Fi. In such embodiments, the network interface 303 may additionally include ethernet ports, fiber-optic ports, or antennas in order to facilitate access to these networks. The network interface 303 may additionally incorporate other communications methods and standards, for example Bluetooth, Wi-Fi Direct, near-field communication, infrared transmissions, or other subsystems for electronically communicating data and media to networks external to the client device 300. In addition to allowing the client device 300 to connect to external networks, the network interface may optionally provide additional communication with global positioning systems (GPS) in order to determine the location of the client device 300, for example, when a picture is taken. Such GPS data may be requested by the processor 301 and/or stored in the memory 302 so that it may be used by the client device 300.

The media sensor hardware 304 may be used by the processor in order to capture media items to be used by a client device which is acting as a photographer device, or to capture a unique identifier for another client device 300. In some exemplary embodiments, the media sensor hardware 304 may take the form of a camera for capturing still or video images, such as a compact digital camera implemented using CMOS active pixel sensors, or other image sensors capable of capturing one or more images. The media sensor hardware 304 may additionally include a microphone for recording voice or other sound data which may be included alongside or separately from image data captured by a camera. In some embodiments of the client 300, the media sensor hardware 304 may be additionally configured to supply captured media items to the processor 301 and/or memory 302 for further processing either automatically or based on user input such as that provided by the input interface 306. For example, a client device 300 may incorporate code executed by the processor 301 for editing a photo, for example by applying filters, cropping the image, or removing unwanted visual artifacts after the media sensor hardware 304 has captured a media item. While some exemplary embodiments of the media sensor hardware 304 take the form of a camera with or without a microphone, the inventors contemplate that media capture may include many other forms of captured information, for example data captured by sensors such as an accelerometer, gyroscope, magnetometer, thermometer, barometer, or other sensor capable of generating data which may be transmitted as a media item according to the present invention.

The display output 305 may take the form of a liquid crystal, LED, or OLED screen, or other form of display technology serving the purpose of presenting a visible output to a user. In some exemplary embodiments, the display output 305 may be used to present a user interface to a user of the client device 300. The display output 305 may additionally be connected to an input interface 306, such as a touch screen overlayed on the display output 305. In some embodiments, the display output 305 may not be a single screen or device, but rather may take the form of one or more displays depicting the same or different media items, user interfaces, or other outputs, and each may be connected to one or more input interfaces 306. The inventors also contemplate that in some embodiments, the input interface 306 may not be directly or indirectly connected to the display output 305. For example, in some embodiments the input interface 306 may take the form of a mouse or other pointer device and/or a keyboard, which may be provided alongside or separately from a touch screen connected to the display output 305. When the input interface 306 is not connected to the display output 305 directly, it may still communicate with the other components of the client device 300 via the data bus 310 and similarly be controlled by the processor 301. As discussed previously, in some embodiments the display output 305 may be controlled entirely or in part by a GPU portion of the processor 301.

The data bus 310 may provide an electronic communication background which allows the various components of the client device 300 to communicate with one another. In some embodiments, the processor 301 may use the data bus 310 to communicate with the memory 302, network interface 303, media sensor hardware 304, display output 305, and/or input interface 306. The processor may make use of software, optionally stored in the memory 302, such as hardware drivers provided by the manufacturer of the client device 300 or by the manufacturer of specific components thereof in order to facilitate this communication, and may make use of the memory 302 as a location in which to store data on which it is performing operations. As an example, the processor 301 may direct the display output 305 to present a user interface to a user by communicating with it via the data bus 310; upon receiving user input from the input interface 306 through the data bus 310, the processor may then direct the media sensor hardware 304 to capture media which is transported, again by way of the data bus 310, to the memory 302 for further storage.

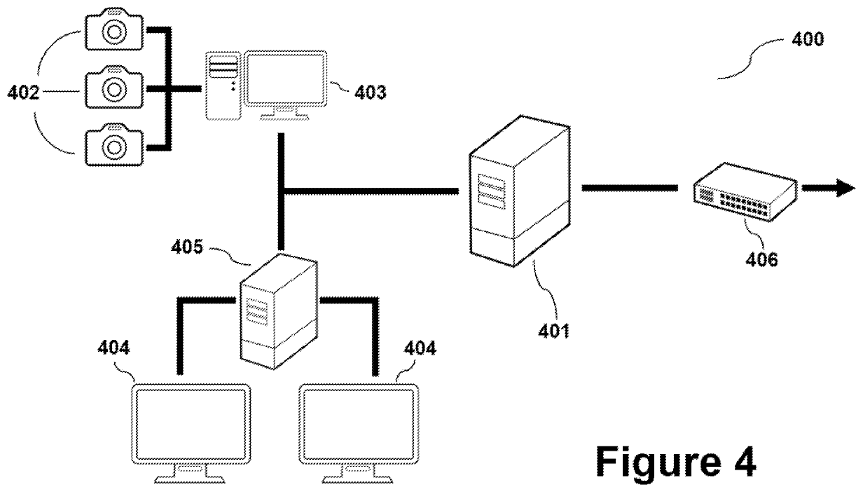

FIG. 4 depicts an alternative embodiment for an enterprise client 400 which has been assembled at a larger scale for use in large events or by commercial enterprises. The present embodiment may, for example, be used at an entertainment venue, providing an automated system by which many event-goers may provide their unique identifiers in order to securely receive media captured by the enterprise client 400 operated by the venue, or securely transmit their own media to the venue for display as part of an entertainment event. For example, such an embodiment may include a central server 401 which contains a processor and memory for implementing the client's portion of the SLIME technique. The central server 401 may additionally include software for managing other portions of the enterprise client 400, for example, the central server 401 may include software which instructs the display system 405 to display particular media items or identifiers, or which instructs the photographer system 403 to capture media items or identifiers. The central server 401 may additionally allocate space in its memory or other data storage in which media items may be transiently stored while they are processed and uploaded before being securely deleted. The enterprise client may additionally include a network hub 406, such as a switch, router, or any other combination of network infrastructure in order to electrically connect, by wire, wirelessly, or by any other means, the components of the enterprise client 400 so that they may communicate with one another. The network hub 406 may additionally be further connected to an outside network such as the internet, a cellular network, or any other network by which data and media may be transferred to an external system or server as contemplated by the present disclosure.

The enterprise client may additionally include subsystems such as the photographer subsystem 403 and the display subsystem 405. For example, the photographer subsystem 403 may include a computer running software by which a photographer can operate one or more media sensors 402; alternatively, the photographer subsystem 403 may be configured with software allowing the one or more media sensors 402 to take pictures automatically or in response to some customer action. Further, the photographer subsystem 403 may not take the form of a separate computer at all, and instead reside as either software, hardware, or a combination thereof incorporated into the central server 401. As another example, the display subsystem 405 may include a computer system configured with software to, automatically or with input from a user, cause the displays 404 to present, for example, a user interface, one or more unique identifiers, and/or one or more media items.

The display subsystem 405 may additionally take the form of a smaller, integrated system which is incorporated into the displays 404 or alternatively into the central server 401. The present disclosure additionally contemplates that the photographer subsystem 403 and the display subsystem 405 may also be integrated with one another, such that the same computer system operates, through hardware, software, or a combination thereof, as a photographer subsystem 403 or a display subsystem 405. In such an embodiment, the media sensors 402 and the displays 404 may similarly be combined into a single housing or electronic product.

The present disclosure further contemplates that a one or more input devices and/or input interfaces may be provided as part of an enterprise client device 400. For example, input devices in the form of a touch screen, keypad, keyboard, mouse, microphone, or other form of input or related interface may be disposed on or connected to, the one or more displays 404 and/or the display subsystem 405. Further, such input devices and interfaces may be incorporated into the media sensor hardware 402 and/or the photography subsystem 403. Such input devices may communicate with different computer systems incorporate into the enterprise client 400, for example through the network hub 406, for example by wired or wireless connection, so that input can be received at the central server 400, the photography subsystem 403, and/or the display subsystem 405.

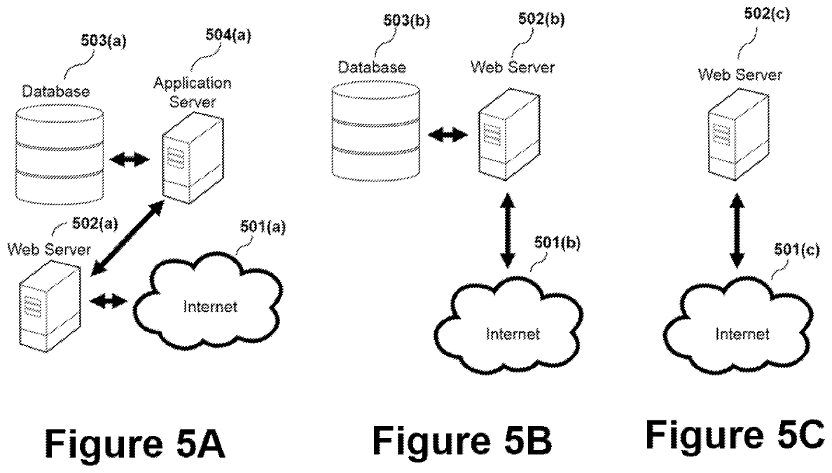

FIG. 5A, FIG. 5B, and FIG. 5C show examples of a server system which may be included in some embodiments of the present invention. It is intended that FIG. 5A, FIG. 5B, and FIG. 5C be read together so that the reader may develop and understanding of the various advantages and disadvantages of various server configurations which may be used to accomplish the present invention, particularly where it relates to the secure exchange and deletion of media. Collectively, FIG. 5A, FIG. 5B, and FIG. 5C depict, for example, the internet 501(a), 501(b), 501(c), which here depicts an example of the external network connection which may be made available to a server such as the web server 502(a), 502(b), 502(c) so that it can communicate with other computers, mobile systems, or other electronic devices, for example, client devices such as those presented in the present disclosure. FIG. 5A and FIG. 5B additionally depict a database 503(a), 503(b), which may be connected to the server system in order to store, modify, look up, and securely delete data such as media items, media data, user data, or other such data necessitated by the server system as disclosed. FIG. 5A additionally depicts an application server 504(a) as a portion of the server system for receiving and processing data according to both incoming requests and the content of the database 503(a). The following descriptions provide greater detail on each figure.

FIG. 5A depicts an example of a server system which may be included in some embodiments of the present invention. For example, a web server 502(a) may expose an application programming interface (“API”), HTTP server software, and/or other interfaces by which a client or other device may access a web service or application, to the internet 501(a). By publicly exposing these interfaces via the internet 501(a), they become accessible by client devices or applications which may target one or more of those interfaces in order to issue requests to the web server 502(a). The web server 502(a) may include standard server hardware, including a processor, memory, storage, and network interfaces needed to communicate with other components of the server system. The web server 502(a) may further incorporate software in order to allow it to operate, for example, an operating system such as Windows Server, Ubuntu Server, Fedora, or other software distribution suitable for operating a server. In addition to an operating system, the web server 502(a) may additionally include necessary public and/or proprietary software packages to allow it to serve a webpage and handle incoming HTTP requests, for example using Apache2, Nginx, and/or IIS; the web server 502(a) may further include web frameworks such as Flask, Apache Wicket, Django, and/or Ruby on Rails for similar purposes.

Additionally, the web server 502(a) may also incorporate software which has been specifically built in accordance with the features of the present disclosure and is not based on a pre-existing framework or other web development project base. It should be noted that while the present disclosure attempts to present useful examples of such software aspect of server systems, software and web development are volatile fields with a constantly set of best practices and preferred software and tools. Thus, the inventors also contemplate that these functionalities may be achieved in the future through the use of additional software in combination with such aspects, or through entirely different software. Further, the present disclosure additionally contemplates that the web server 502(a) may consist of multiple computer systems, or additional software, operating together in order to achieve the functions of the web server 502(a) as set forth herein. As a further example, the web server 502(a) may additionally incorporate load balancing software or hardware where the server system is expected to receive a very large number of requests from clients or other end users.

Embodiments of server systems consistent with the present disclosure may additionally include an application server 504(a). The application server 504(a) may take the form of hardware and/or software consistent with that used for the web server 502(a) and discussed above. For example, the application server may include a processor, memory, storage, networking hardware, an operating system, and various services and frameworks upon which web applications may be built. The application server 504(a) may further serve to host one or more such web applications, which may function to receive media items, requests, or other information from the web server 502(a) after they are provided by the client through the API or other exposed interface. In other embodiments, the application server 504(a) may additionally expose its own API or other interfaces, through the internet 501(a), to which client devices or applications may send messages such as HTTP requests directly. The present disclosure additionally contemplates that the application server 504(a), though depicted as a single computer system, may actually consist of multiple computer systems, each with potentially different hardware, software, and specific functions operating together to accomplish the function of the application server 504(a) as disclosed in this and other embodiments.

The application server 504(a) may additionally be connected to a database 503(a), which may store files, variables, entries, or other data relating to the present invention. Like the webserver 502(a) and application server 504(a), the database 503(a) may be constructed using known hardware and/or software for managing and operating a computer system incorporated into a server system. In addition to this, a database 503(a) may require more storage, for example as may be provided by one or more hard drives, solid state drives, etc. Because the database stores data, its storage needs may far surpass the needs for t other server system components, for example the application server 504(a) or web server 502(a). The database 503(a) may additionally incorporate specialized data base software in order to allow it to effectively store, search, and retrieve data which it holds in storage, for example software for creating and maintaining a relational database, for example MySQL, PostgreSQL, SQLite, and/or Microsoft SQL Server. Software for creating and maintaining a non-relational (NoSQL) database may also be chosen, based on developer needs, for example MongoDB, Oracle NoSQL, Apache Ignite, Apache River, or others.

The present disclosure additionally contemplates that though the database 503(a) is depicted as a single item, it may take the form of one or more physically or virtually separated database systems. In some embodiments, the database 503(a) may be divided such that one database system stores media data, for example pictures, audio, and video, while other database systems store non-media data, for example unique identifiers, information regarding media items, user authentication data. In embodiments where a separate media database is used, the database 503(a) may additionally include tables or other data storage for listings specifying the location of media resources in the media database. As contemplated above, databases 503(a) may incorporate specific hardware and software in order to enable and/or facilitate their operation, and where the database 503(a) consists of multiple database subsystems, it may additionally be preferable to use different sets of hardware and software tailored to the needs of the specific subsystem. Regardless of the physical and virtual division of the database 503(a), it serves the general purpose of acting as a datastore for files, data, tables, relationships, and variables which may be used by clients connecting to the server system through the internet 501(a), or used by the web server 502(a) or application server 504(a) themselves.

For example, the database 503(a) may store, among other things: media items which have been uploaded to the system, the unique identifiers associated with one or more of those media items, media information about one or more of those media items such as a GPS location at which media was created, a date/time at which media was created or uploaded, and/or other relevant data which systems consistent with the present invention may require. The database 503(a) may further include stored data used for user authentication, for example usernames and corresponding passwords. It should be noted that such user authentication data may require enhanced security considerations, for example, applying encryption to the portion of the database 503(a) which contains such information. Additionally, or alternatively, the portion of the database 503(a) used to store passwords may avoid storing plain-text passwords altogether in favor of hashed password values, such as those which may be produced when a password is passed through a hash function like a message digest algorithm, for example MD5, or a Secure Hash Algorithm (“SHA”), for example SHA-256, though the present disclosure notes that numerous other hash functions for generating hashed inputs exist.

FIG. 5B depicts another example of a server system which may be implemented in some embodiments of the present invention. In such embodiments, the application server 504(a) of FIG. 5A may instead be incorporated into the web server 502(b), which in turn may communicate with the database 503(b) and with client or other connecting devices through the internet 501(b) in a manner similar to that shown in FIG. 5A. Though the depiction of FIG. 5B presents fewer individual components, the present disclosure contemplates that the functionality disclosed in FIG. 5A and any associated descriptions may still be present in the resultant server system. For example, the web server 502(b) may operate to run and make available web services and web applications such as those contemplated in the present disclosure and which may be included in the application server 504(a) of FIG. 5A.

In some further embodiments, the web server 502(b) may additionally include virtualization software by which a single computing system is partitioned to operate as one or more virtual computing systems—often referred to as virtual machines. Such virtualization software may include, for example, Oracle's VirtualBox, the Kernel-based Virtual Machine included in Linux, Hyper-V, and/or more specialized software used for managing large-scale virtualization such as Kubernetes; additionally, such software may include partial virtualization and container software such as Docker which may be used for similar purposes. When virtual machines are used, the resulting virtual structure may resemble FIG. 5A, with virtual machines filing the role of, for example, the web server 502(b), the database 503(a), the application server 504(a), and/or other components which developers see fit to virtualize or containerize.

FIG. 5C depicts yet another example of a server which may be implemented in some embodiments of the present invention. In these embodiments, most or all components of the server system may be virtualized, with a single physical web server 502(c) operating the virtualized components and providing access through the internet 501(c) and interconnecting said components using a virtual LAN or similar virtualized networking technique. The depiction of FIG. 5C may be especially applicable in some embodiments of the present invention where the server system may be implemented entirely on virtualized hardware accessed through various cloud-base web hosting services, for example Amazon Web Services, Microsoft Azure, Google Cloud Platform, or other such cloud computing platforms and are often suitable for development cases in which a solution may need to scale rapidly during times of high demand. In some other embodiments, the virtualized hardware may not run on a cloud-based service offered by a third party, but rather on hardware owned and operated by the developers implementing a system consistent with the present invention. The present disclosure additionally contemplates that in smaller-scale solutions which do not anticipate heavy use, a physical implementation of FIG. 5C may also be suitable, wherein a single physical web server 502(c) may include all necessary software to implement the present invention, for example, a developer may place an http server, an API, database software, and related application software directly onto a single computer connected to the internet 501(c), such solutions may sacrifice performance for simplicity, but nonetheless may be consistent with the present disclosure.

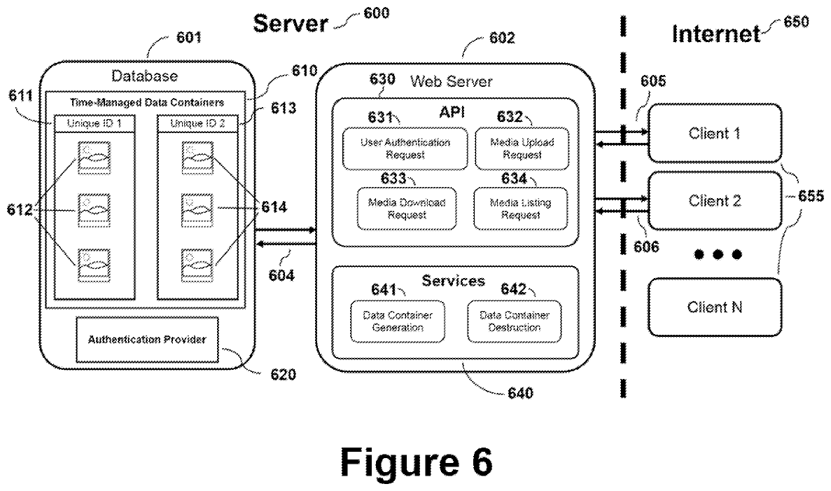

FIG. 6 is a diagram of a media exchange platform and associated application which may be included in some embodiments of the present invention. The diagram shows how an application making use of the SLIME technique might be constructed at a software level by presenting individual programmatic components and their interrelationships. The left side of the diagram corresponds to aspects of the web application which are present in in the server 600, namely the web server 602 and database 601. The right side of the diagram corresponds to devices which access the server 600 through the internet 650, namely one or more clients 655. The diagram presented is not intended to provide the only working configuration for a web application consistent with the present application, but rather provides an exemplary configuration which may be instructive to one attempting to implement the SLIME technique in a way which is consistent with the present invention. It should also be noted that the web server 602 includes functionality which may be included in an “application server” in some embodiments in the present disclosure, such as the application server 504(a) in FIG. 5A. The diagram depicted thus most closely resembles the server configuration presented in FIG. 5B.

For example, the one or more clients 655 may access the server 600 through a client application which makes http requests to the web server 602 through an API exposed for this purpose 630. While the present disclosure addresses communication between the server 600 and one client 655, the server 600 may be configured to support any number of client messages 605, 606. A number of examples of request which the API might be configured to support are additionally provided. The API may be configured to support user authentication requests 631, in which a client 655 may transmit a username or other identifier, for example an email address or phone number, and a password or hashed password for verification with the server 602. The present disclosure additionally contemplates that some embodiments consistent with the present invention may also make use of social media-based login credentials, which authenticate users through established social media platforms, possibly eliminating the need for a separate password. The API may additionally be configured to support a media upload request 632, in which a client 655 may transmit information relating to a media item being uploaded. The API may additionally be configured to support a media download request 633, in which a client 655 identifies a media item which it wishes to download or a media listing request 634, in which a client 655 requests a list of media items, for example media items available for display or download. In order to respond to these requests, the API 630 may electronically communicate 604 with the database 601, or may make use of services 640 included in the web server 602. The present disclosure additionally contemplates that the API 630 may be built using any number of programming languages or existing frameworks such as ASP.NET Core, Express.js, Flask, or a variety of other frameworks and tools suitable for constructing an API 630 which may, for example, make use of a representational state transfer architecture (also known as a REST API, or a RESTful API).

The database 601 may include a variety of data entries for use by the web server 602; for example, the database provider may include time-managed data containers 610 such as the container for Unique ID 1 611 and the container for Unique ID 2 613 which are used to store media items (e.g., the media items of 612 and 614) which have been received from clients 655 via the webserver 602. The database may additionally contain data for authentication provision 620. As a narrative example of how the database may be used, a client 655 may send a request 605 to the API 630 for user authentication 631 by communicating a username and hashed password. The API 630 either on its own or via a service 640 configured to perform authentication, may communicate 604 with the database 601 to compare the submitted username and hashed password to records stored for authentication 620 in the database 601. In response to successful authentication, the webserver 602 may respond 605 to the client 655 with authentication credentials, confirming that the client 655 has successfully logged in.

As described, in addition to the API 630, the web server 602 may additionally include services 640, software or other code which runs on the web server 602 in order to provide internal functionality needed to manage the server 600, for example, one function of the services 640 may be to make changes to the database 601. For example, the services 640 may include code or software for data container generation 641 and data container destruction 642. These services may be used to generate or remove a time-managed data container 610 in the database 601. As another illustrative example, a client 655 may transmit a request 605 to the webserver 602 through the API 630 to upload media 632, specifying a unique identifier to which the media is targeted. In response, the API 630 may communicate 605 a resource by which the client 655 can initiate an upload of media. Upon receiving the uploaded media content from the client 655, the web server 602 may process the upload through its services 640, for example, the data container generation code 641 may cause a new time-managed data container to be created, for the unique identifier which was sent, like the one shown in the diagram for Unique ID 1 611. The database 601 may then store the uploaded media so that the data container 611 maintains a reference to the media associated with its unique identifier. Just as many clients 655 may connect to the server 600, the database 601 may contain many different time-managed data containers 610, each identified with one or more different unique identifiers, e.g., those depicted as 611 and 613, and each monitoring the time for which they have existed in the database. At some point in the future, for example, 24 hours, a time-managed data container 610 may “expire,” at which point the data container destruction 642 service 640 may operate to permanently delete the container and its associated media.

In yet another illustrative example, a client 655 may communicate 605 a request to the web server 602 via the API 630 to view a listing of available media 634. Such a request, for example, may include a unique identifier associated with the client 655 sending the request, and may additionally include that client 655's authentication token, acquired through authentication as described above. Inventors also note that in some embodiments, the authentication token may itself serve as the unique identifier for the client 655. The web server 602 may then determine, via the API 630 or services 640, whether or not the client 655 is authorized to receive such a media listing. In this example, let us assume that the client 655 is authorized to receive a listing of media items contained in the data container associated with Unique ID 2 613. The web server 602 may then communicate 605 a response to the client 655 listing one or more of the media items 614 labeled according to that container 613, or which are otherwise relevant to the request made. The listing may additionally contain resources such as a link, URL, or other information which the client 655 may use to request a particular media item listed. For example, a client 655 may initiate a media download request 633 via the API 630 in order to cause one of the corresponding media items 614 to be transferred to the client 655.

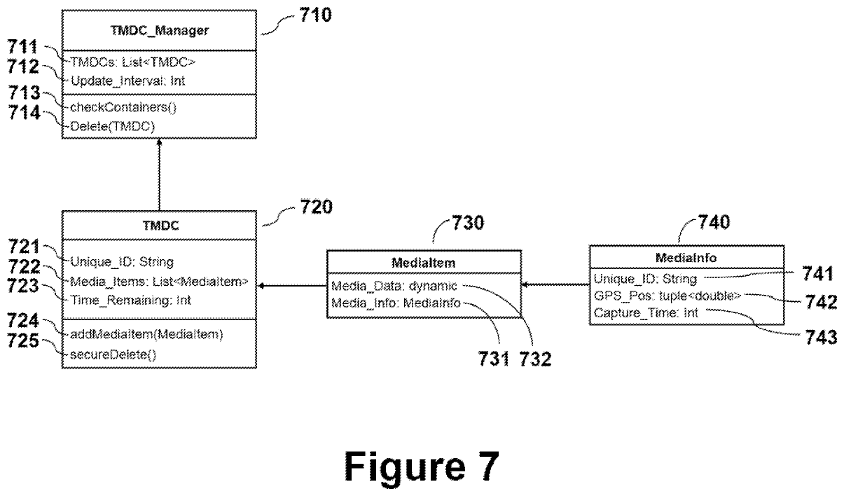

FIG. 7 shows a class diagram depicting programmatic structures which may be used in some embodiments of the present invention to implement the time-managed data container (“TMDC”) programming pattern referenced in above. It should be noted that while the class diagram depicts one possible implementation of the TMDC pattern, generally referencing syntax familiar to users of, for example, the C# programming language, the TMDC pattern may be implemented through a variety of software design approaches, which may depend upon the chosen programming language and development environment in which it is implemented. Thus, the class diagram should be read in order to better understand how the TMDC pattern may be implemented in some embodiments of the invention rather than as an inflexible rubric for the pattern.

For example, the TMDC pattern may include a TMDC_Manager class 710 which defines a programmatic structure for managing time-managed data containers. The TMDC_Manager class 710 may additionally include fields, properties, or other instance variables, for example, a list of TMDC objects 711 which may store a series of references to TMDC 720 objects which will be managed. Additionally, the TMDC_Manager 710 may include an update interval member variable 712, for example, an integer indicating the number of seconds which pass between sweeps of the list of TMDC objects 711. The TMDC_Manager 710 may also incorporate methods containing code for managing a TMDC 720, for example, the checkContainers() method 713, which may be called every Update_Interval 712 seconds to check each item in the TMDCs list 712 and ensure that it has not expired. If the TMDC 720 object has expired, then the TMDC_Manager 710 may use its Delete(TMDC) 714 method to destroy the target TMDC object 720 which may be input as a parameter. Inventors additionally note that TMDC_Manager 710 may be implemented as a standard class to be instanced during application runtime, but may also be implemented as a static class which exists globally and may act as a sole manager of TMDC objects 720.

The TMDC pattern may additionally include a TMDC class 720, defining a time-managed data container object, like the ones contained in the TMDC_Manager's 710 TMDCs list 711. The TMDC class 720 may include member variables such as a Unique_ID 721, which may be a String type (though the present disclosure also contemplates that this member could be any type capable of distinguishing a sufficiently large number of values, such as an Integer). The Unique_ID 721 may specify one or more unique identifiers with which the TMDC object 720 is associated. The TMDC 720 may additionally contain a member variable representing a list of MediaItems objects 722 which it contains. The TMDC object 720 may additionally include a Time_Remaining member variable 723 which may take the form of an integer measuring the number of seconds of remaining lifetime for the TMDC 720.

The TMDC class 720 may additionally include methods, such as the addMediaItem(MediaItem) 724 method, by which a MediaItem object 730 may be added; this method may, for example, be called by the TMDC_Manager 710 when media is to be added to the TMDC 720. The TMDC class 720 may further incorporate a secureDelete() 725 method, which may similarly be called by the TMDC_Manager 710 in order to affect a permanent and secure deletion of the MediaItems 730 stored in the Media_Items 722 member variable.

The TMDC pattern implemented in some embodiments of the present invention may additionally include a MediaItem class 730 which describes a piece of media listed in a TMDC 720. The MediaItem 730 may be quite simple, and may incorporate a member variable, Media_Data 731, referencing the data of the actual media stored in the MediaItem 730 (Media_Data 731 is given the “dynamic” type, because it may vary based on the media contained, e.g., a video may be a different type from a picture). The MediaItem class 730 may additionally incorporate a Media_Info 732 member variable, which may reference a MediaInfo 740 object containing information pertinent to the media contained by the MediaItem 730. This MediaInfo class 740 may list a variety of information about a parent MediaItem 730 which may be used by varying portions of the application. For example, the MediaInfo 730 may include the Unique_ID 741 to which the parent MediaItem 730 is directed, a GPS_Pos 742 specifying a location at which referenced media was captured, and/or a Capture_Time 743 specifying a time at which referenced media was captured.

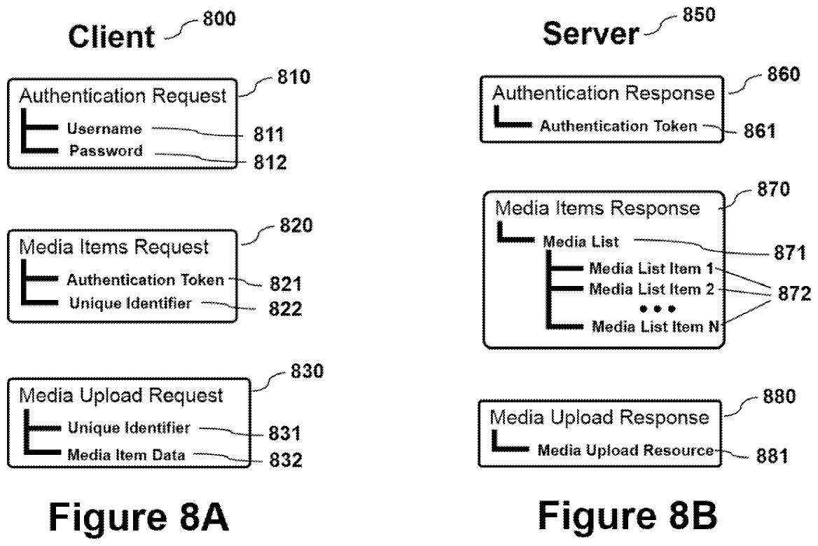

FIG. 8A and FIG. 8B depict messages which may be sent between a client 800 and server 850. FIG. 8A shows examples of requests which may be sent from the client 800 to the server 850. Similarly, FIG. 8B shows examples of responses from the server 850 to the client 800 corresponding to the requests of FIG. 8A. For example, a client 800 may generate an authentication requests 810 which may include a username 811 and a password 812. The server 850 may then generate an authentication response 860 containing an authentication token 861 in reply.

A client 800 may additionally generate a media items request 820 which may include an authentication token 821 and a unique identifier 822. The present disclosure additionally contemplates that in some embodiments, the authentication token 821 may itself be the unique identifier 822, or may otherwise be incorporated into the unique identifier 822. The server 850 may, in response, generate a media items response 870 containing a media list 871 of media list items 872 which match the information contained in the media items request 820.

A client 800 may additionally generate a media upload request 830, which may include a unique identifier 831 and media item data 832. The server 800 may respond to such a request with a media upload response 880 which may contain a media upload resource 881. In some embodiments of the present invention, the media upload request 830 may contain media item data 832 in the form of information about the media rather than the actual data which the media item comprises. In particular embodiments of the present invention, the media item data 832 may further comprise, for example, GPS coordinates at which media was captured, a time at which media was captured, or an identifier for a media capture session which the media is a part of In some embodiments, the media upload response 880 may include a media upload resource 881 containing information, for example a link to an upload host by which the media item may be uploaded by the client 800. This may be especially necessary where media is large in which case the media upload resource 881 may be used to establish more advanced means of performing a file upload, for example using a chunked uploading process. Alternatively, the data describing the media to be uploaded may be directly included in the media upload request 830 as the media item data parameter 832 in which case the media upload response 880 may include only information pertaining the upload's success or other such upload receipt data. The present disclosure further contemplates that the media item data 832 may include one or more media items, such that the media item data 832 includes a media item set.

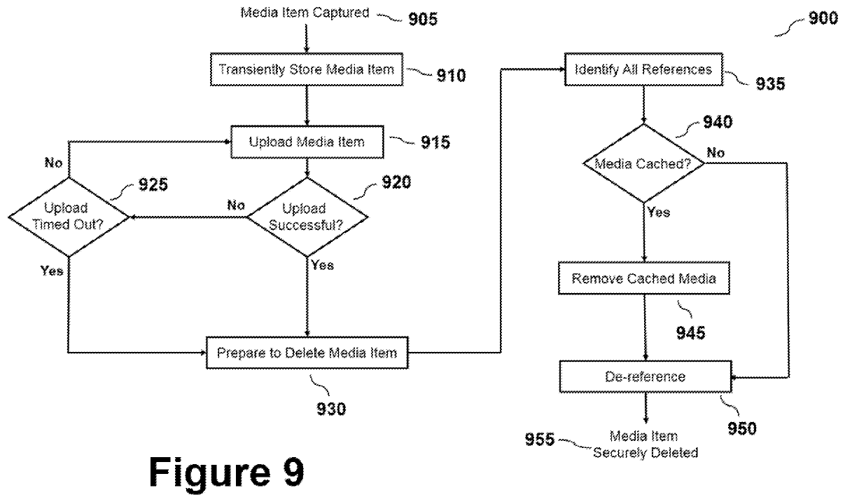

FIG. 9 shows a flow chart describing a media management process, from capture 905 to secure deletion 955, which is consistent with the present disclosure. The media management process 900 may begin as soon a media item is captured 905 by a client device acting as a photographer. Next, the client device may transiently store 910 the media item. Transient storage as shown in 910 may be accomplished by ensuring that media is only stored in volatile memory, or if it is stored on disk, that it is stored in a caching directory or other designated location for temporary files which is not easily accessed by a user of the device, for example, a folder marked as “hidden” by the device's filesystem or operating system. As another example, transient storage 910 may be accomplished by storing media in an encrypted form such that it is only accessible to an intended recipient using their cryptographic key, such embodiments are explored in greater detail elsewhere in the present disclosure. In still other embodiments, transient storage may additionally include maintaining a data referencing the location of such stored media so that it may later be collected for cleanup.

The client device may then upload 915 the captured media item, for example, to a remote server such as the one described above. In some embodiments consistent with the present invention, the client device may await a response, checking if the upload is successful 920 and repeating the upload media item step 915 until the upload is successful 920 or the upload process times out 925. Additionally, in some embodiments, the upload step 915 and/or the checks for success of an upload 920 and/or whether or not an upload has timed out 925, may further comprise awaiting favorable network conditions, for example, a Wi-Fi network becoming available in order to save limited cellular data), before uploading the media item 915. In either instance, the device may prepare to delete the media item. The deletion process may include identifying all references to the stored media 935, for example, references to the media in memory or temporarily stored media files which have been written to disk. If cached files exist 940 then they may first be removed 945 from storage; in either case, the device may then de-reference any storage or memory locations which previously contained the media, allowing it to be garbage collected and/or overwritten by the operating system or hardware included in the device. Upon completion of these steps, the media item has been securely deleted 955, for example, it may no longer be accessed by a user of the device.

A server may follow a similar process for the purposes of secure deletion, starting from step 930 (prepare to delete media item). Though a server may store media in a database rather than a cache, it may similarly be securely deleted 955 by removal of such media 945 from the location in the database and removing lingering references 950. The present invention additionally contemplates that the media management process 900 disclosed is only one way of ensuring secure deletion of data, and a number of techniques and data security considerations known in the art may be applied depending on use case in order to achieve an adequately secure outcome. For example, a client device may be more vulnerable to a user attempting to retrieve cached media than a data server would be; thus, the latter may not require as many or the same steps as the process shown in 900 to achieve secure deletion.

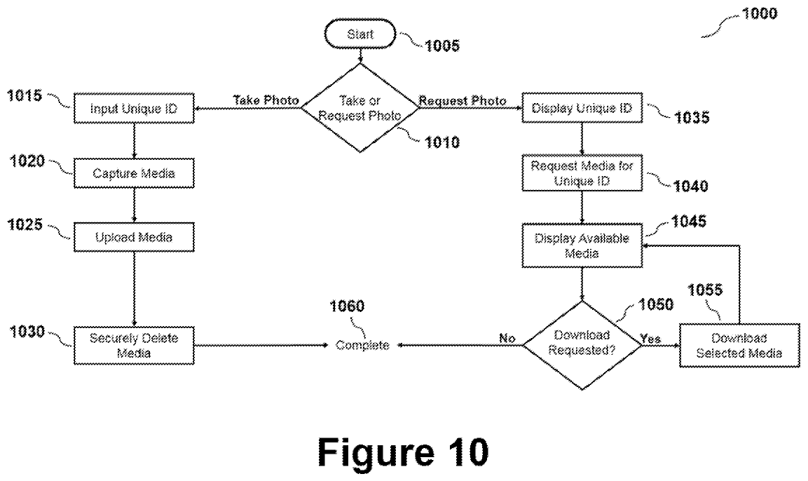

FIG. 10 shows a flow chart providing an overview of control logic 1000 for an application, particularly a client application, consistent with some embodiments of the present invention. For example, such control logic 1000 may start 1005 when a user opens the application on a mobile phone, loads a web app on a computer or otherwise initiates the client code. The process then follows two paths based on a user's choice to either take or request a photo 1010. If a user chooses to take a photo, the device may next prompt a user to input a unique identifier 1015 for another user who has selected the request photo option 1010. For example, this may be done by entering a pin, scanning a QR code, or by other input methods. In some embodiments consistent with the present invention, the input unique ID step 1015 may additionally include generating, inputting, or otherwise designating a media capture session which the media to be captured is a part of Next, the user captures media 1020, for example by using their camera to take a picture, which is then uploaded 1025 to a server as described elsewhere in the present disclosure. Following uploading the media 1025, the captured media may then be securely deleted 1030 in order to prevent the photographer client from accessing the media, as is consistent with the SUME practice. At this point, the application control cycle has completed 1060, and the application may return to its main page, close, or otherwise conclude or restart the control process.

A user who chooses to request a photo 1010 may first cause the application to display a unique ID 1035 corresponding to that user, for example so that it can be shared with and entered by a user taking a photo as in step 1015. Such sharing and entry may be accomplished by using, for example, an alphanumeric pin or a scannable code such as a QR code. Next, the application may send a request for media corresponding to its unique ID 1040 from the server, and display available media 1045 indicated by the response received from the server. The display of available media 1045 may additionally allow a user to select to download media 1050. If a user selects one or more media items for download, the application may download the selected media 1055 and resume displaying available media 1045 until a user has finished selecting media for download, at which point the application control flow is complete 1060.

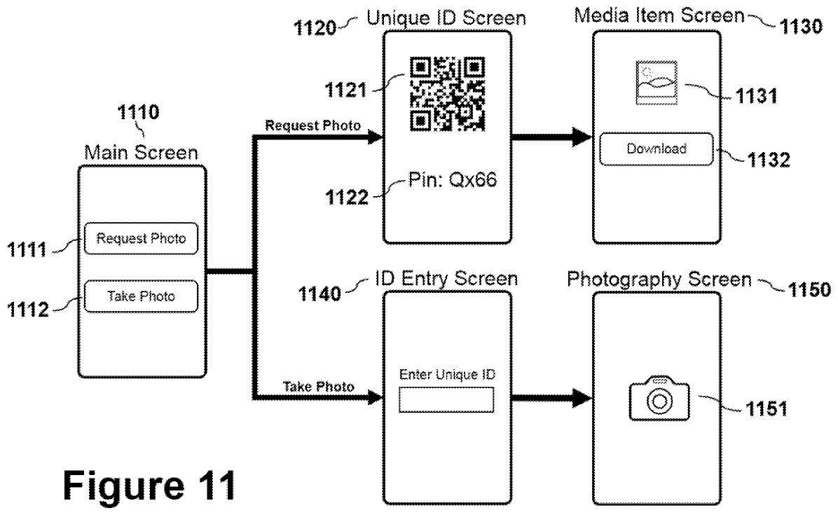

FIG. 11 depicts a user interface storyboard for a mobile application consistent with certain embodiments the present invention. The depicted user interface and other such user interfaces consistent with the present embodiment may be included in, for example, client devices as described elsewhere in the present disclosure—a device featuring a user interface in accordance with the present invention may also be called a user interface device. As an example of a user interface, the main screen 1110 may provide user controls such as buttons, gestures, or other input options to request a photo 1111 or take a photo 1112. These options are depicted as buttons, but may also be accomplished by other input, for example, by swiping left or right on the screen. Next, if a user has selected to take a photo, the UI may change to an ID entry screen 1140 where a unique ID, such as the pin 1122 may be entered. Alternatively, a QR code 1121 or similar visual identifier may be entered by camera instead. Following identifier entry, the user may then be presented with a photography screen 1150 which provides camera functionality 1151, for example by using the system camera or by presenting a custom camera for capturing images. After successful image capture, the user interface may return to the main screen 1110 or progress to additional screens not shown in the flow diagram.

A user who selects request photo 1111 on the main screen 1110 may then be taken to a unique ID screen 1120 which may present either a unique identifier in the form of a scannable code 1121 such as a QR code, an alphanumeric pin 1122, or both a scannable code 1121 and an alphanumeric pin 1122 provided separately or together (for example, a scannable code 1121 may contain an alphanumeric pin 1122 in its encoded data). Following this screen, a user may proceed to a media item screen 1130 which displays one or more media items 1131 uploaded to the server and directed toward their unique identifier, it may additionally provide a button or other UI accessible feature by which a user can download 1132 the one or more media items. The present disclosure additionally contemplates that additional screens (not pictured) may precede or follow the media item screen 1130, for example a payment screen which prompts a requesting user to pay the photographer before media items are made available for download, or a rating screen, which allows a user to rate the photographer from whom they received a media item based on their reliability, performance, etc. While ratings are well-established in the field of internet services, the present embodiment contemplates generally that they may be stored in a database and be associated with the account or login of a user for whom the rating was submitted.

The present disclosure additionally contemplates that one or more aspects of the user interface storyboard, for example screens 1110, 1120, 1130, 1140, and 1150, may be hybridized or otherwise combined together without departing from the spirit of the present disclosure. As one example, the main screen 1110 and unique ID screen 1120 may be combined so that a single screen presenting a unique identifier such as a scannable code 1121 or alphanumeric pin 1122 along with a control for taking a photo 1112. In such an embodiment, a user may not need to request a photo 1111, but rather could simply communicate their unique identifier 1121, 1122 to another user who may have chosen to take a photo 1112 and awaiting input for the ID Entry Screen 1140.

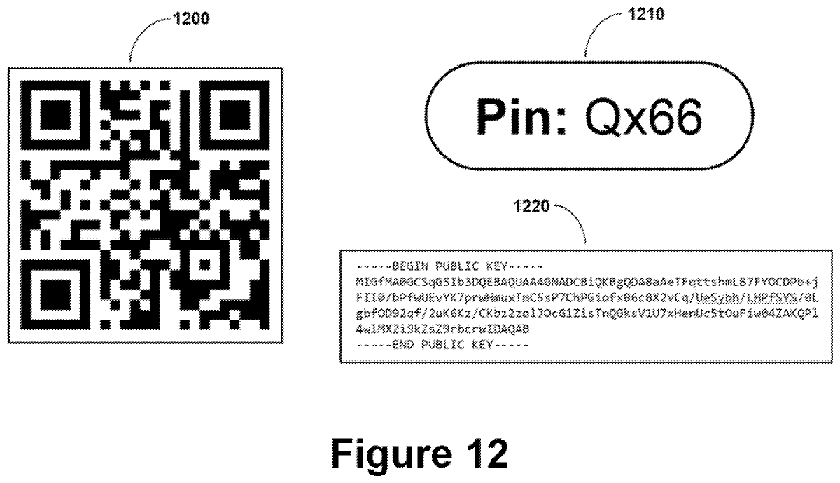

FIG. 12 depicts a few exemplary embodiments of unique identifiers consistent with the present invention. For example, the unique identifier may take the form of a scannable code 1200, which uses a matrix of colored squares in a standardized pattern to store data, for example a standard sized QR scannable code 1200 in the figure may store a sequence of over four thousand alphanumeric characters, providing effectively infinite possible unique identifiers. The present disclosure additionally contemplates that the scannable code 1200 depicted in this figure may take many forms other than a QR code; for example, a bar code may also be used, though it will likely yield fewer possible unique identifiers. Additionally, the scannable code 1200 may take the form of a customized two-dimensional bar code, optionally branded to match the application displaying it. The present disclosure also contemplates that a unique identifier may take the form of an alphanumeric pin 1210, such as the four-character pin depicted here. Such an alphanumeric pin may additionally be made longer than the four characters shown in the figure in order to permit more possible unique identifiers to exist simultaneously. As contemplated by the present disclosure, an alphanumeric pin 1210 is described as “alphanumeric” for ease of reference, and may comprise any combination of letters, numerals, and special characters or encoding schemes e.g., Unicode or ASCII characters; for example, an alphanumeric pin 1210 may include only letters, only numerals, etc. Further, the unique identifier may take the form of the character content of some other data object, for example, the RSA public key shown at 1220. Such a data object may additionally take the form of the authentication token contemplated elsewhere in this disclosure, such that returned by the server to a client when a user logs in—though in some embodiments it may be preferable not to display such a unique identifier as it may compromise the security of the access token.

The present disclosure additionally contemplates that some embodiments of the invention may further adapt the unique identifier so that an identifier can be canceled and reissued in order to preserve the anonymity of users. For example, a user may send a request to the server to cancel their current unique identifier and replace it with a new one, or the server may be configured to automatically cancel a unique identifier after a time-managed data container based on it has expired. Further, the unique identifier may serve to provide encryption protection for exchanged media when it contains a cryptographic key such as in 1220, a topic explored more in the following section.

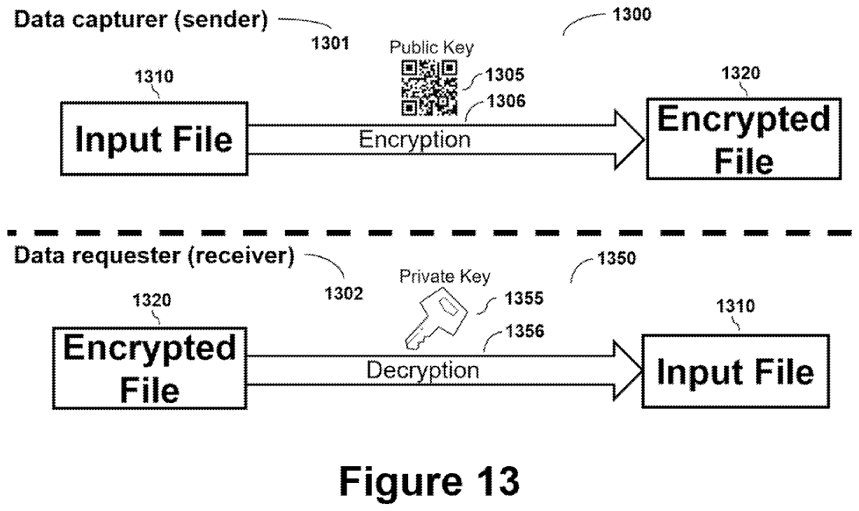

FIG. 13 depicts an end-to-end encryption implementation consistent with certain embodiments of the present invention, generally using asymmetric-key encryption. The encryption stage 1300 of the implementation occurs when a data capturer 1301 (the sender, or photographer, of some embodiments contemplated by the present disclosure) passes an input file 1310, such as a media item, through an encryption algorithm 1306 which takes as input a cryptographic key called a public key 1305 belonging to the data requester 1320 (the receiver, or photo requester, of some embodiments disclosed herein). The public key 1305 may be integrated into the data contained in the unique identifier as contemplated in 1220 of FIG. 12 in order to facilitate this process, for example, by including the public key in the data of a QR code. The resulting encrypted file 1320 cannot be returned to its initial form, even if the public key 1305 is known.

The resulting encrypted file 1320 may then be transmitted to the data requester 1302 without concern that it might be intercepted and viewed; once the encrypted file 1320 is received, the decryption stage 1350 may begin. A data requester 1302 decrypts a file encrypted 1320 with their public key 1305, by running it, along with their own private key 1355 (a cryptographic key known only to the data requester 1302) through the appropriate decryption algorithm 1356 for the encryption algorithm 1306 used in the encryption stage 1300. Once the decryption algorithm 1356 has finished, the data requester 1302 is left with the same input file 1310 originally encrypted. The present disclosure additionally contemplates that encryption implementations consistent with the present invention may also be used in accordance with the implementation depicted in FIG. 13. For example, many forms of end-to-end encryption using a variety of cryptographic systems and keys could be used in some embodiments consistent with the present invention. In still other embodiments consistent with the present invention, encryption, such as the implementation depicted in FIG. 13, may be additionally adapted to encrypt a media item after it is captured and during the time that it is transiently stored, for example, to a client device, so that the data capturer 1301 is unable to decrypt it without a cryptographic key outside their ownership. In such an implementation, the data requester 1302 may use a key, for example a private key 1355, in their possession or known by the server providing the media item so that only they can decrypt the media item.

In closing, the present disclosure additionally contemplates that where examples of software, code, data, etc. are provided using particular syntax, for example the C# programming language syntax used at points in the present disclosure, the same software, code, or data may readily be achieved using a variety of other languages, design techniques, and/or frameworks. For example, a program written in C# may just as well be written in C, C++, Java, JavaScript, Python, or any other language chosen by a developer wishing to build embodiments consistent with the present invention. Additionally, while a number of examples throughout the specification are directed toward, for example, a photographer capturing a photograph with a camera, these portions of the disclosure should not be construed to limit such embodiments to only photography applications, and generally may equally be applied to a more generic scenario contemplating a sending user who captures media using any form of media sensor hardware.

While the present invention has been shown with reference to particular exemplary embodiments disclosed herein, it would be understood by those skilled in the art that various changes from form and detail may be made without departing from the spirt and scope of the invention as defined by the following claims.

What is claimed is:

1. A system for secured unidirectional media exchange, comprising: a first user interface device, a second user interface device, a server, and an application having a user interface, wherein said application comprises code capable of:
receiving a first unique user identifier associated with a first instance of the user interface through a second instance of the user interface, wherein said second instance of the user interface is associated with a second unique user identifier and executes on said second user interface device;
capturing a media item set through the second instance of the user interface using media sensor hardware of said second user interface device, and storing said media item set in a database such that said media item set is securely deleted from the second user interface device after being stored;
associating said first unique user identifier with each media item in the media item set;
storing, in the database, said associated first unique identifiers;
receiving, from the first instance of the user interface, a unique user identifier associated with said first instance of the user interface, wherein said first instance of the user interface executes on said first user interface device; and
sending the media item set to said first instance of the user interface.

2. The system of claim 1, wherein the media item set further comprises one or more of a photo, a video, and/or audio.

3. The system of claim 1, wherein the first unique identifier and the second unique identifier are each one of a scannable code, a QR code, an alphanumeric pin, or a cryptographic key.

4. The system of claim 1, wherein said code is further capable of authenticating, via a server, the second user interface device.

5. The system of claim 1, wherein capturing a media item set through the second instance of the user interface further comprises associating the media item set with a media capture session.

6. The system of claim 1, wherein said code is further capable of receiving, from the first instance of the user interface, a rating associated with a user of the second user interface device. A method for secured unidirectional media exchange comprising:
receiving, from a first client application, a media upload request including one or more media items, wherein each media item is associated with a first unique identifier;
storing each of the one or more media items in a time-managed data container corresponding to the first unique identifier associated with said media item, wherein said storing further includes generating the time-managed data container corresponding to said first unique identifier if one does not exist;
receiving, from a second client application, a media inventory request including a second unique identifier;
responding to said media inventory request with a list of available media items based on a determination of whether or not the second client application is authorized to make the request, and a comparison between the first unique identifier and the second unique identifier;
monitoring the time-managed data container to determine if a termination condition has occurred; and
securely deleting the time-managed data container and its contents upon determining that a termination condition has occurred.

8. The method of claim 7, wherein the one or more media items further comprise at least one of: a photo, a video, and/or audio.

9. The method of claim 7, wherein the first unique identifier and the second unique identifier are each one of: a scannable code, a QR code, an alphanumeric pin, or a cryptographic key.

10. The method of claim 7, wherein the time-managed data container further comprises a database entry.

11. The method of claim 7, wherein the termination condition further comprises one of: an expiration of a time limit, the receipt of a message from the first client application or the second client application, or the receipt of a message from a service.

12. The method of claim 7, wherein responding further comprises providing one or more download links for the available media items.

13. The method of claim 7, wherein responding further comprises sending media information about one or more of the available media items.

14. The method of claim 13, wherein the media information further comprises
a GPS location or a time at which the media item was captured, and/or a media capture session.

15. A secured unidirectional media exchange device comprising:
at least one non-transitory memory storing instructions;
a display;
media sensor hardware;
a network interface;
an input interface;
one or more processors in communication with at the at least one non-transitory memory, the display, the media sensor hardware, the network interface, and the user input interface, wherein the one or more processors execute the instructions to cause the device to:
present a user interface on the display, the user interface configured to receive input from the input interface;
receive, through the user interface, a first unique identifier associated with a first user;
transiently capture, using the media sensor hardware, one or more media items;
initiate a secured unidirectional media exchange with a server, wherein initiating said secured unidirectional media exchange comprises:
sending the first unique identifier to the server via an application programming interface,
uploading the one or more media items to the server, and
securely deleting the one or more media items upon completion of said uploading;
wherein the user interface is further configured to present a second unique identifier associated with a second user.

16. The device of claim 15, wherein the display further comprises one of: an LCD screen, an LED screen, or an OLED screen, and wherein the input interface further comprises a touch screen disposed on said display.

17. The device of claim 15, wherein the first unique identifier and second unique identifier further comprise at least one of: a scannable code, an alphanumeric pin, and/or an encryption key.

18. The device of claim 15, wherein securely deleting the one or more media items further comprises identifying one or more cached media items and deleting said cached media items.

19. The device of claim 15, wherein the instructions are further configured to cause the client to: authenticate the second user by communicating an authentication request to the server.

20. The device of claim 15, wherein the device is a mobile phone, digital camera, or enterprise client.
